(19) United States
(12) Patent Application Publication
(10) Pub. No.: US 2004/0003095 A1
(43) Pub. Date: Jan. 1, 2004

(54) Method for multi-function device to provide a user with access to at least one function, and a multi-function device arranged in accordance with the same method

(75) Inventor: Natasha Ann Gitany-Alonso, Webster, NY (US)

Correspondence Address: Patent Documentation Center, Xerox Corporation, Xerox Square, 20th Floor, 100 Clinton Ave. S., Rochester, NY, 14644, US

(73) Assignee: Xerox Corporation

(21) Appl. No.: 10/183,598

(22) Filed: Jun. 26, 2002

(51) Int. Cl. G06F 15/16

(52) U.S. Cl. 709/228; 709/229

(57) ABSTRACT

A multi-function device is arranged for coupling to a network and is further arranged to perform plural functions. A user of the multi-function device has a user network access information that enables the user to access the network. The multi-function device is arranged to provide the user with access to at least one function of the plural functions based on the user's user network access information. The user initiates a user log-in sequence with the multi-function device by activating an included log in/out button and then inputs the user network access information by activating an included input means. After the user log-in sequence is complete, the multi-function device provides the user with access to at least one function of the plural functions.

### FIELD OF THE INVENTION

This application relates generally to multi-function devices and more particularly to a method for a multi-function device to provide a user with access to at least one function.

### BACKGROUND OF THE INVENTION

In today's electronic era log-in and log-out of electronic networked systems has become a de-facto industry standard. It is equivalent to and as common as using keys to open and lock the doors of your house or car. Both in everyday tasks and in digital tasks, your principal action is to use a key or password to be able to perform the act of locking your car or to log in or out of your digital network accounts.

The main difference and problem is that while leaving the door of your house or car unlocked, you leave yourself exposed to possible intruder entrance, the odds are much lower than those of leaving an open and active digital networked accounts. You may wonder why? Simply because user interactions with a machine that is used by many others in your office environment happen on a synchronous one-behind-the other (“walk-up”) format. Hence, it's important to successfully log-out of your digital networked accounts in order to preserve your privacy and the integrity of your data files and electronic communications. The assumed risk is that if a user does not log-out of his or her accounts after completing a job, this leaves his or her account profile available for the next walk-up user. For example, the next walk-up user might choose to use a typical “scan to e-mail” function to send a harmful message to other co-workers

Currently the “Access” button function works to allow the machine or system administrator to log-in the “tools” section of the user interface which then allows the administrator to control an set-up most of the machine functionality. The Access button is also used to allow machine users to track the machine usage by department or teams by creating an account, like a pin number, for each team to use whenever wanting to use the copier or digital networked printer. This functionality is known by the system engineering community as Auditron and Accounting.

The usage of electronic devices is emerging daily with the vast usage of personal computers, personal digital assistants (PDA's), and with the burst of the internet as a medium used for customer service, on-line applications, online recruitment (e.g., resume posting), online e-commerce sites (user purchasing items via the web), etc. To gain access to any of these electronic systems, users are required to have an account or profile that they can use to identify themselves with the machine. Hence, the creation of electronic profiles linked to users via a unique login and password than, when entered, activates their profile and account.

### SUMMARY OF THE INVENTION

In one aspect of the invention, there is described, in a multi-function device that is arranged for coupling to a network and that is further arranged to perform plural functions, a method for the multi-function device to provide a user with access to at least one function of the plural functions, the user having a user network access information that enables the user to access the network, the method comprising the steps, by the user, of initiating a user log-in sequence with the multi-function device by activating an included log in/out button and inputting the user network access information by activating an included input means and, by the multi-function device, of providing the user with access to at least one function of the plural functions.

In another aspect of the invention, there is described a multi-function device that is arranged for coupling to a network and that is further arranged to perform plural functions, the multi-function device arranged to provide a user with access to at least one function of the plural functions in accordance with a method, the user having a user network access information that enables the user to access the network, the method comprising the steps, by the user, of initiating a user log-in sequence with the multifunction device by activating an included log in/out button and inputting the user network access information by activating an included input means and, by the multifunction device, of providing the user with access to at least one function of the plural functions.

### BRIEF DESCRIPTION OF THE DRAWINGS

FIG. 1 is a block diagram that shows a user 1 and a multi-function device 100 that is arranged for coupling to a network 199 and that is further arranged to perform plural functions 150.

FIG. 2 is a flow diagram that depicts a first embodiment of a method 200 for the device 100 to provide the user 1 with access to at least one function of the plural functions 150.

### DESCRIPTION OF THE PREFERRED EMBODIMENTS

Briefly, in accordance with the present invention, a multi-function device is arranged for coupling to a network and is further arranged to perform plural functions. A user of the multi-function device has a user network access information that enables the user to access the network. The multi-function device is arranged to provide the user with access to at least one function of the plural functions based on the user's user network access information. The user initiates a user log-in sequence with the multifunction device by activating an included log in/out button and then inputs the user network access information by activating an included input means. After the user log-in sequence is complete, the multi-function device provides the user with access to at least one function of the plural functions.

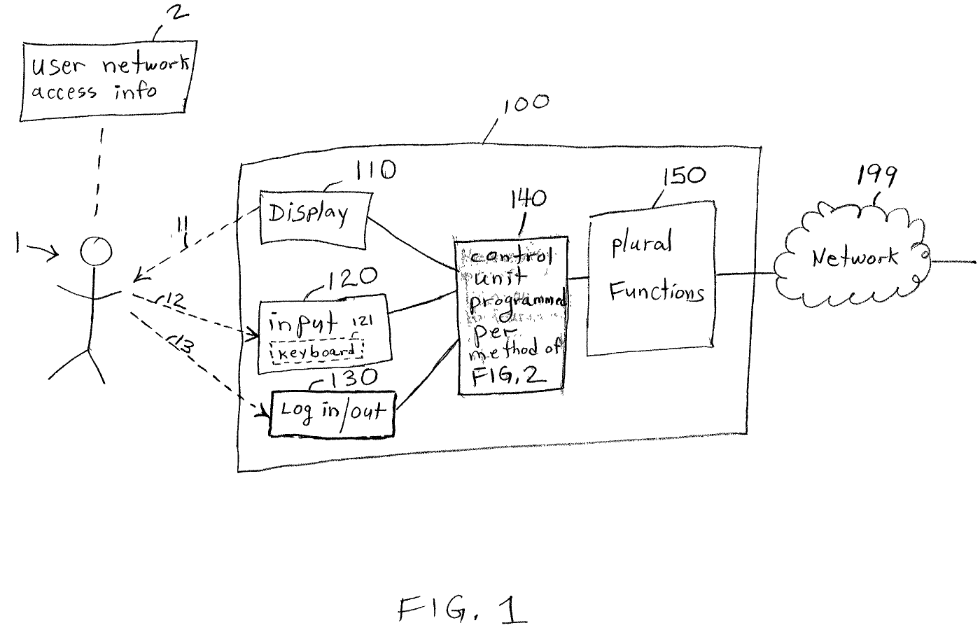

Referring now to FIG. 1 there is shown a multi-function device 100 that is arranged for coupling to a network 199 and that is further arranged to perform plural functions 150.

In one embodiment, the network 199 comprises an internet.

The plural functions 150 comprise any of a scan to file repository function, a scan to e-mail function, a fax function, an i-fax function, a copying function and a printing function.

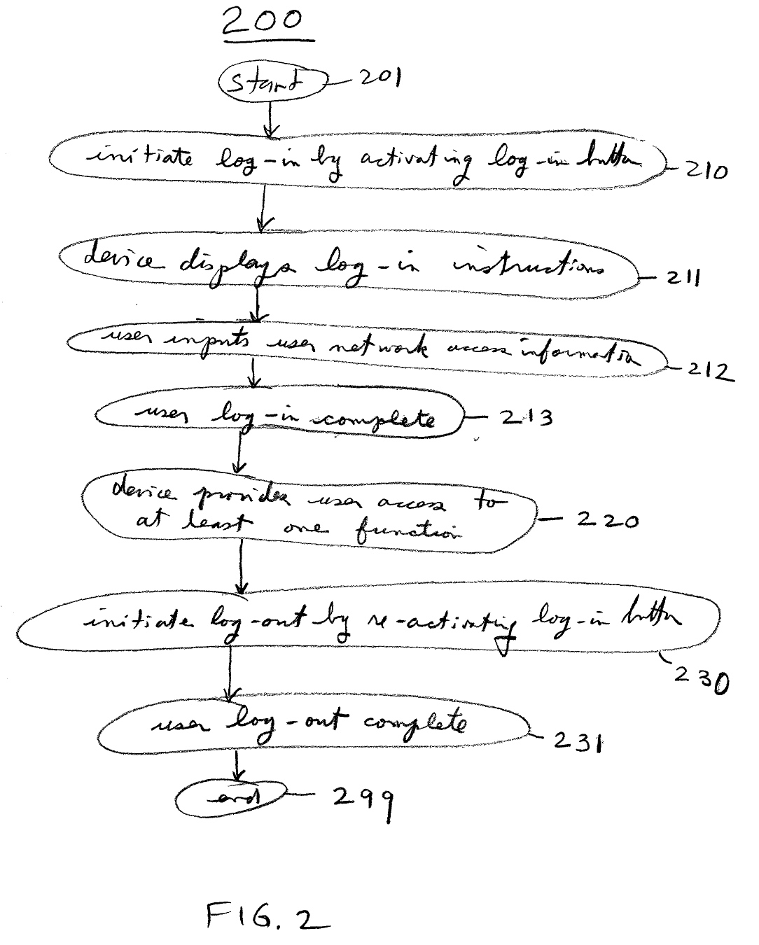

As shown, the multi-function device 100 is arranged to provide a user 1 with access to at least one function of the plural functions by means of a control unit 140 that is programmed with a method that is described in connection with FIG. 2 below. The control unit 140 may comprise, for example, a suitably-programmed microprocessor or micro-controller.

Still referring to FIG. 1, the user has a user network access information 2 that enables the user to access the network 199. In one embodiment, the user network access information 2 is any of a user network password, user identification code, user “ID”, user profile and user account.

As shown, the multi-function device 100 includes a display 110 that is arranged to display information to the user 1, the information displayed being depicted by a first broken arrow 11.

Also, the multi-function device 100 includes a input means 120 arranged for the user 1 to input information. The user l's act of inputting information to the multifunction device 100 by means of the input means 120 is depicted by a second broken arrow 12. In one embodiment, the input means 120 comprises a keyboard 121, the keyboard 121 being depicted in broken lines.

The multi-function device 100 includes a log in/out button 130 that is arranged to support a user log-in sequence and a user out-out sequence that are described in connection with FIG. 2 below. The user 1's manual activation of the log in/out button 130 is depicted by a third broken arrow 13.

Still referring to FIG. 1, to summarize, the multi-function device 100 is arranged to provide the user 1 with access to at least one function of the plural functions 150 in accordance with a method that is described in connection with FIG. 2 below.

Referring now to FIG. 2, there is a flow diagram depicting the method or process, generally depicted by the reference number 200, for the multi-function device 100 to provide the user 1 with access to at least one function of the plural functions 150.

The process 200 starts, step 201, and then goes to step 210.

In step 210, the user initiates a user log-in sequence with the multi-function device 100 by activating 13 the included log in/out button 130. The process then goes to step 211.

In step 211, the multi-function device 100 displays 11 user log-in sequence instructions to the user by means of the display 110. The process then goes to step 212.

In step 212, the user inputs 12 the user network access information 2 by activating the included input means 120.

In one embodiment, the input means comprises a keyboard 121 and the user inputting step 212 comprises activating 12 the keyboard 121.

After step 212, the process goes to step 213.

In step 213, the user log-in sequence is complete. The process then goes to step 220.

In step 220, the multi-function device 100 provides the user 1 with access to at least one function of the plural functions 150.

In one embodiment, the plural functions 150 comprise a scan to file repository function and the multi-function device providing step 220 comprises providing the user 1 with access to the scan to file repository function.

In another embodiment, the plural functions 150 comprise a scan to e-mail function and the multi-function device providing step 220 comprises providing the user 1 with access to the scan to e-mail function.

In still another embodiment, the plural functions 150 comprise a fax function and the multi-function device providing step 220 comprises providing the user 1 with access to the fax function.

In a further embodiment, the plural functions 150 comprise an i-fax function and the multi-function device providing step 220 comprises providing the user 1 with access to the i-fax function.

In a still further embodiment, the plural functions 150 comprise a printing function and the multi-function device providing step 220 comprises providing the user 1 with access to the printing function.

In yet still another embodiment, the plural functions comprise a copying function and the multi-function device providing step 220 comprises providing the user with access to the copying function.

After step 220, the process goes to step 230. In step 230, the user initiates a user log-out sequence with the multi-function device 100 by re-activating the log in/out button 130. The process then goes to step 231.

In step 231, the user log-out sequence is complete.

After step 231, the process ends, step 299.

In summary, there has been described a multi-function device 100 that is arranged for coupling to a network 199 and that is further arranged to perform plural functions 150, the multi-function device 100 arranged to provide a user 1 with access to at least one function of the plural functions 150 in accordance with a method 200, the user having a user network access information 2 that enables the user 1 to access the network 199, the method 200 comprising the steps, by the user, of initiating (step 210) a user log-in sequence with the multi-function device 100 by activating an included log in/out button 130 and inputting (step 212) the user network access information 2 by activating 12 an included input means 120 and, by the multi-function device 100, of providing (step 220) the user 1 with access to at least one function of the plural functions 150.

The invention combines the copier/digital networked functionality with that of the multi-function devices to create a unified coherent login/logout procedure. The invention also uses industry standard terminology for equivalent actions on other digital products.

This invention can easily be implemented using existing copier/digital networked technologies.

Moreover, the invention blends the world of the copiers and digital networked printers with the multifunction and e-services environments. This invention leverages and improves the login/logout user interactions and the “Access” button functionality design by unifying similar actions under one main function, embodied in the invention's log in/out button 130. The log in/out button 130 thus effectively supplants the Access button previously available on the machine's hard control panel, thus creating a coherent procedure and user experience in a “one-button” action for all machine users.

This field is evolving by moving from the copier-only environment to digital and multi-function environments in which login and authentication procedures are of paramount importance to preserve the security and integrity of the systems' users and their data. The log in/out button 130 does just that, it blends the previous Access button functionality with that needed to perform scan services activities available with multi-function machines, e.g., scan to e-mail and scan to file, among others.

Also, this invention also improves the usability and operability of the multifunction device 100 by creating a simple, one-step, coherent process.

The invention is attractive because it blends together the asynchronous (standalone copiers) and synchronous (digital networked printers and multifunction devices) environments under one unified functionality and user experience.

Moreover, this invention is believed to offer the following advantages over previous access/login procedures:

It enhances and eases the login/access procedures.

It eliminates the need of having to go through two separate login procedures, that is, one for gaining access to the machine (Access and Auditron functionality) and other login to authenticate the user when using any of the scanning services, that is, scan to e-mail, scan to file, I-fax, etc.

It increases user productivity.

It enhances the security and integrity of people networked accounts.

It increases the usability of the multi-function device 100.

It increases customer satisfaction.

It automatically allows tracking of feature usage on the basis of the user 1's individual user network access information 2.

This invention addresses problems identified in formal usability testing conducted for the scan to e-mail functionality. These tests were conducted with outside participants and with current Xerox customers. Throughout the testing cycles it was found that users were confused by the duality of both the Access button available within the hard control panel and the login/logout button displayed within the soft user interface. This invention addresses these problems.

The invention's log in/out button 130 is expected to be part of any hard control panel with Access/Auditron and/or Authentication needs on machines released in the future.

The invention's log in/out button 130 replaces the traditional Access button typically used in control panels of previous machines.

This invention enables quick, easy and reliable log-in and log-out of user and administration accounts on shared network devices. It combines the accounting, auditron and log-in functions into a single hard button on the control panel. It greatly simplifies the log-in procedure, allowing for better east of use and helps prevent a user from forgetting to log-out, thus allowing others to use the user's own account.

This invention may be implemented in any device that serves multiple users and requires individual account log-ins.

Further, this invention allows all users—system administrators, machine administrators and machine users—to log-in the same way.

While various embodiments of a method for a multi-function device to provide a user with access to at least one function, and a multi-function device arranged in accordance with the same method, in accordance with the present invention, have been described hereinabove, the scope of the invention is defined by the following claims.

What is claimed is:

1. In a multi-function device that is arranged for coupling to a network and that is further arranged to perform plural functions, a method for the multi-function device to provide a user with access to at least one function of the plural functions, the user having a user network access information that enables the user to access the network, the method comprising the steps, by the user, of initiating a user log-in sequence with the multi-function device by activating an included log in/out button and inputting the user network access information by activating an included input means and, by the multi-function device, of providing the user with access to at least one function of the plural functions.

2. The method of claim 1, the input means comprising a keyboard, the user inputting comprising activating the keyboard.

3. The method of claim 1, the multi-function device including a display that is arranged to display information to the user, the method including a step by the multifunction device of displaying user log-in sequence instructions by means of the display.

4. The method of claim 1 including a subsequent step, by the user, of initiating a user log-out sequence with the multi-function device by re-activating the log in/out button.

5. The method of claim 1, the plural functions comprising a scan to file repository function, the multi-function device providing step including providing the user with access to the scan to file repository function.

6. The method of claim 1, the plural functions comprising a scan to e-mail function, the multi-function device providing step including providing the user with access to the scan to e-mail function.

7. The method of claim 1, the plural functions comprising a fax function, the multifunction device providing step including providing the user with access to the fax function.

8. The method of claim 1, the plural functions comprising an i-fax function, the multi-function device providing step including providing the user with access to the i-fax function.

9. The method of claim 1, the plural functions comprising a printing function, the multi-function device providing step including providing the user with access to the printing function.

10. The method of claim 1, the plural functions comprising a copying function, the multi-function device providing step including providing the user with access to the copying function.

11. A multi-function device that is arranged for coupling to a network and that is further arranged to perform plural functions, the multi-function device arranged to provide a user with access to at least one function of the plural functions in accordance with a method, the user having a user network access information that enables the user to access the network, the method comprising the steps, by the user, of initiating a user log-in sequence with the multi-function device by activating an included log in/out button and inputting the user network access information by activating an included input means and, by the multi-function device, of providing the user with access to at least one function of the plural functions.

12. The multi-functional device of claim 11, the input means comprising a keyboard, the user inputting comprising activating the keyboard.

13. The multi-functional device of claim 11, the multi-function device including a display that is arranged to display information to the user, the method including a step by the multi-function device of displaying user log-in sequence instructions by means of the display.

14. The multi-functional device of claim 11 including a subsequent step, by the user, of initiating a user log-out sequence with the multi-function device by re-activating the log in/out button.

15. The multi-functional device of claim 11, the plural functions comprising a scan to file repository function, the multi-function device providing step including providing the user with access to the scan to file repository function.

16. The multi-functional device of claim 11, the plural functions comprising a scan to e-mail function, the multi-function device providing step including providing the user with access to the scan to e-mail function.

17. The multi-functional device of claim 11, the plural functions comprising a fax function, the multi-function device providing step including providing the user with access to the fax function.

18. The multi-functional device of claim 11, the plural functions comprising an i-fax function, the multi-function device providing step including providing the user with access to the i-fax function.

19. The multi-functional device of claim 11, the plural functions comprising a printing function, the multi-function device providing step including providing the user with access to the printing function.

20. The multi-functional device of claim 11, the plural functions comprising a copying function, the multi-function device providing step including providing the user with access to the copying function.

21. The multi-functional device of claim 11, the network comprising an internet.

22. The multi-functional device of claim 11, the user network access information comprising any of a user network password, user identification code, user ID, user profile and user account.
